(19) United States
(12) Patent Application Publication
(10) Pub. No.: US 2012/0081221 A1
(43) Pub. Date: Apr. 5, 2012

(54) Vehicle, in particular a hybrid vehicle, having an electrical device

(76) Inventors: Bernd Doerr, Wallduern (DE); Roland Schleser, Saarbruecken (DE); Daniel Damm, Ludwigsburg (DE); Andreas Heyl, Ludwigsburg (DE)

(21) Appl. No.: 12/998,681

(22) PCT Filed: Oct. 15, 2009
(86) PCT No.: PCT/EP2009/063502

§ 371 Date: Dec. 20, 2011

(30) Foreign Application Priority Data
Nov. 20, 2008 (DE) 10 2008 043 909.6

(51) Int. Cl. B60Q 1/00

(52) U.S. Cl. 340/436

(57) ABSTRACT

In a vehicle, e.g., a hybrid vehicle, having an electrical device, which has an inadmissibly high voltage for being touched by a person, a signaling sensor configured to respond in the event of an accident is connected to a warning device for signaling the voltage level.

### BACKGROUND OF THE INVENTION

1. Field of the Invention

The present invention relates to a device and a method for providing a warning in a vehicle, in particular a hybrid vehicle, having an electrical device, which has an inadmissibly high voltage for being touched by a person.

2. Description of Related Art

Vehicles are known in the related art, in particular electric or hybrid vehicles, which have electrical devices conducting an inadmissibly high voltage for being touched by a person. Electrical devices of this type are known, for example, as high-voltage systems, i.e., such devices that have a voltage over 60 V DC or 26 V AC, so that they are considered dangerous according to the definition of ISO 6469. Such high voltages are, however, required in such devices in order to keep the current intensity necessary for a certain required performance low, and thus to avoid unnecessarily large conductor cross sections and thus an unnecessarily high weight.

Persons are protected against indirect contact, in particular in cases of fault, with such parts under high voltage by additional basic insulation, additional covers, and an electrical separation of the high-voltage systems from the low-voltage systems, in particular vehicle electrical systems. Furthermore, periodic or continuous insulation monitoring and error current monitoring are used, such high-voltage systems being turned off as additional functional measures. In the case of electrical separation of a high-voltage system and a low-voltage system, there is no risk due to indirect contact until two insulation faults occur, when, for example a housing is at high voltage plus due to a fault and the body is at high voltage minus due to a second fault. The relevant standard requires in this case that the power in the high-voltage system be reduced within two seconds, for example by disconnecting the high-voltage battery and discharging the temporary energy storage. A plug-in device for contacting the high-voltage module of a hybrid vehicle and a high-voltage module of a hybrid vehicle are known from published German patent application document DE 10 2006 016 137.8; they achieve voltage isolation with the aid of a control contact in the plug-in device if a fault occurs.

It is disadvantageous here that appropriate isolation of the plug-in device, in particular of the control contact, and the function of other, above-described functional measures do not function under unfavorable conditions in the event of an accident, since, for example jamming or damage of a type has occurred that functional elements providing this protection become non-operational. Under unfavorable conditions, it is possible in such cases that the functional measures for reducing the power in the high-voltage system cannot be implemented and that, at the same time, a double insulation fault exists. In such cases, persons, in particular emergency service people, are exposed to risk in the event of contact with the vehicle body due to the high voltage of the vehicle's electrical device. Such a risk is not recognizable from the outside.

An object of the present invention is to protect persons, in particular emergency service people, via warnings recognizable from the outside, from damage due to contact with faulty electrical devices/high-voltage systems of vehicles affected by damage or an accident.

### BRIEF SUMMARY OF THE INVENTION

For this purpose, a vehicle, in particular a hybrid vehicle, having an electrical device is proposed, the electrical device having an inadmissibly high voltage for being touched by a person, it being provided that this vehicle has a signaling sensor which responds in the event of an accident, a warning device being connected to the signaling sensor for signaling the voltage level. Consequently, if the vehicle suffers an accident, the signaling sensor responds, whereby the connected warning device signals the voltage level. Any sensors that detect constellations typical for an accident which do not occur during normal driving operation of the vehicle may be used as signaling sensors.

In one specific embodiment, the signaling sensor has an acceleration sensor. The signaling sensor itself may be formed as a module of a plurality of sensors, in particular of a plurality of different sensors. It preferably has an acceleration sensor which tests for accelerations that are unusual during normal driving operation, namely acceleration values and acceleration directions. It sensibly tests for accelerations that may be regarded as sufficient conditions for an accident.

The signaling sensor preferably has an air bag sensor. Air bag sensors are used in modern automobiles anyway and may be easily connected to the warning device or associated with or integrated into the signaling sensor.

Particularly advantageously it is provided that the signaling sensor is an element of an air bag controller. The signaling sensor is therefore integrated into the air bag controller, rather than vice-versa, sensors of the air bag controller or air bag sensors being integrated into the signaling sensor. The signaling sensor is therefore associated with the air bag controller, preferably integrated therein, and uses the air bag controller for recognizing and evaluating parameters typical for an accident.

The warning device preferably outputs a visual, acoustic, and/or haptic signal. Visual signals include, for example, blinking or regular light signals from or on existing or specially provided visual signaling devices. Acoustic signals are signals to be perceived by hearing, which are emitted in particular via signaling devices existing in the vehicle, for example horns or acoustic transducers specifically provided for this purpose and which have the advantage of omnidirectionality over visual signals by not requiring the attention of approaching persons. Haptic signals, in particular vibrating signals or similar signals, perceivable via the sense of touch may be considered, for example signals which may be output by an eccentric device. In particular, the output of plain text messages, provided especially in the case of visual signals, or messages in the form of symbols, for example flashing lightning pictograms as they are generally known and point to high voltage in a generally understandable manner.

Furthermore, a method is proposed for warning against an inadmissibly high electric voltage in a vehicle, in particular a hybrid vehicle, preferably as described in the above specific embodiments, the vehicle having an electrical device which has an inadmissibly high voltage level for being touched by a person. It is provided here that in the event of an accident, it is sensed and a warning message is output warning against the inadmissibly high voltage. Sensing preferably occurs, as apparent from the above-described exemplary embodiments, and results in the output of the warning message, making approaching persons, in particular emergency service people, aware of the danger of a high electric voltage and prompting them to take appropriate protective measures.

### BRIEF DESCRIPTION OF THE DRAWINGS

FIG. 1 shows a vehicle having a signaling sensor and a warning device for warning against inadmissibly high voltage.

### DETAILED DESCRIPTION OF THE INVENTION

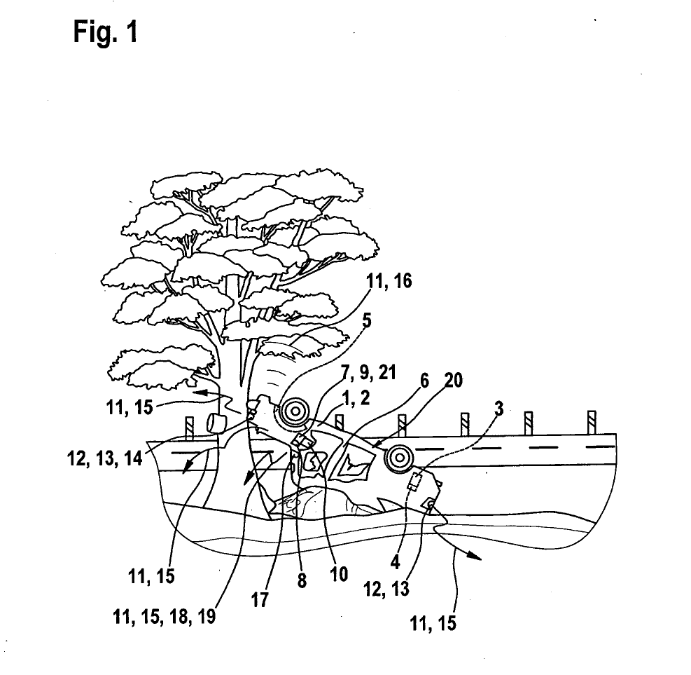

FIG. 1 shows a vehicle 1, namely a hybrid vehicle 2, having an electrical device 3, which includes a high-voltage battery 4 for driving an electric motor 5 of hybrid vehicle 2. Vehicle 1 is in an emergency situation after an accident, in which insulation faults of multiple types may occur due to mechanical damage 6 and functional devices for ensuring electrical safety may have become non-operational. Vehicle 1 has a signaling sensor 7, having at least one acceleration sensor 21 and an air bag sensor 8 and is part of an air bag controller 9. Air bag controller 9 includes an evaluation and computing device, which tests accident-specific data delivered by air bag sensor 8 for accident-specific accelerations, in particular transverse accelerations and acceleration values and vectors that do not occur during normal driving operation and which may constitute a sufficient condition for an accident event. Signaling sensor 7 has sensed the accident and outputs appropriate warning signals 11 via a warning device 10, which is connected to signaling sensor 7 and air bag controller 9, namely via optical devices 12 of vehicle 1, light signals as visual signals 15, for example blinker 13 and headlight 14, pulsed in a certain clock pulse/measure and via alarm signals from a horn (not shown) as acoustic signals 16, which have the advantage of omnidirectionality and require no targeted attention. Furthermore, a warning message 11 as a visual signal 15 may be output in pictogram form 18 via a pictogram output device 20, which is visible in a front windshield 17 of vehicle 1, for example as a high-voltage lightning pictogram 19. In this way, approaching personnel, in particular emergency service people, are sufficiently warned against high voltage which is possibly applied to parts of a body 20 of vehicle 1.

1-6. (canceled)

7. A system for providing a warning against touching of a vehicle containing an electrical device having a dangerous high voltage level, comprising:
a signaling sensor configured to provide a signal in the event of an accident involving the vehicle; and
a warning device connected to the signaling sensor, wherein the warning device is configured to provide a warning signal regarding the dangerous high voltage level.

8. The system as recited in claim 7, wherein the signaling sensor has an acceleration sensor.

9. The system as recited in claim 7, wherein the signaling sensor has an air bag sensor.

10. The system as recited in claim 7, wherein the signaling sensor is an element of an air bag controller.

11. The system as recited in claim 7, wherein the warning device is configured to output at least one of a visual, acoustic, and haptic signal as the warning signal.

12. A method for providing a warning against touching of a vehicle containing an electrical device having a dangerous high voltage level, comprising:
providing, using a signaling sensor, a signal in the event of an accident involving the vehicle; and
providing, using a warning device connected to the signaling sensor, a warning signal regarding the dangerous high voltage level if an accident involving the vehicle has been signaled by the signaling sensor.
